(19) United States
(12) Patent Application Publication
(10) Pub. No.: US 2024/0199927 A1
(43) Pub. Date: Jun. 20, 2024

(54) PHLOROGLUCINOL ACETALDEHYDE RESINS, METHODS OF MAKING, AND USES IN RUBBER COMPOSITIONS

(71) Applicants: SUMITOMO CHEMICAL ADVANCED TECHNOLOGIES LLC, D.B.A. SUMIKA ELECTRONIC MATERIALS, Phoenix, AZ (US); SUMITOMO CHEMICAL COMPANY, LIMITED, Tokyo (JP)

(72) Inventors: Tamon ITAHASHI, Yokohama-si, Kanagawa (JP); Toshihiro NOBUOKA, Pittsburgh, PA (US); Michael C. WALKUP, New Kensington, PA (US)

(21) Appl. No.: 18/550,512

(22) PCT Filed: Mar. 15, 2022
(86) PCT No.: PCT/US2022/020299

§ 371 Date: Sep. 14, 2023

Related U.S. Application Data
(60) Provisional application No. 63/160,996, filed on Mar. 15, 2021.

(51) Int. Cl. C09J 161/06; C08L 7/02; C09J 107/02; C09J 109/06

(52) U.S. Cl. CPC C09J 161/06; C08L 7/02; C09J 107/02; C09J 109/06

(57) ABSTRACT

The phloroglucinolic acetaldehyde resin includes multiple phloroglucinolic units defined by formula (I)

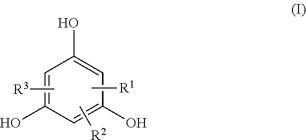

wherein the number of phloroglucinolic unit is an integer from 2 to 20, and at least one of R1, R2, and R3 combines with a second phloroglucinolic unit to form a methyl-substituted methylene bridge, where in the second and third ones of R1, R2 and R3 is a hydrogen atom or combines with another phloroglucinolic unit to form another methyl-substituted methylene bridge, with the proviso that, for any terminal unit of formula (I), any two of R1, R2 and R3 are a hydrogen atom.

### FIELD OF THE INVENTION

This invention relates to phloroglucinolic acetaldehyde resins and methods for making the same. Such phloroglucinolic acetaldehyde resins are liquids and are useful in fabric dipping formulations for treating fibers, filaments, fabrics or cords to enhance their adhesion to rubber compounds. Production of dipping adhesive compositions including such phloroglucinolic acetaldehyde resins in solution and resultant vulcanizable rubber compositions containing a textile material coated with the dipping adhesive composition are also envisioned.

### BACKGROUND OF THE INVENTION

Resorcinol-formaldehyde resins, also referred to as RF resins or resorcinolic resins, which are formed as the reaction product of resorcinol and formaldehyde, have been widely used in various applications including fabric dipping technologies. These dipping technologies have been widely used throughout the rubber and tire industries to enhance the adhesion of rubber reinforcing materials such as fibers, filaments, fabrics or cords of polyesters (such as polyethylene terephthalate (PET) and polyethylene naphthalate (PEN)) and polyamides (such as nylons and aramids) to natural as well as synthetic rubbers. The fabrics are typically treated by dipping or otherwise coating the fabric with an aqueous latex suspension containing the RF resin, which compositions are also referred to as an RFL dip. It will be appreciated that RF resin is a solid, and therefore, must be used in an aqueous latex suspension.

Resorcinolic resins generally have 10 to 20% unreacted or free resorcinol. The presence of free resorcinol, however, can be problematic as a risk for human and environmental health. Formaldehyde also has been used to produce resorcinol-formaldehyde resins for many years. In view of its widespread use, toxicity, and volatility, formaldehyde presents potential health and environmental problems. In 2011, the US National Toxicology Program described formaldehyde as known to be a human carcinogen.

Accordingly, the need exists to create environmentally friendly adhesives that do not use resorcinol and formaldehyde. Unfortunately, all known prior art to date that do not include resorcinol and formaldehyde generally require improved adhesion performance, more practical dip preparation, and longer storage stability.

RF-free dipping resins are known in the art. For example, in U.S. Patent Application Publication No. US 2015/0315410 an aqueous adhesive composition is noted to include an acrylic resin, an epoxy resin, a blocked polyisocyanate and a styrene-butadiene vinylpyridine latex. Besides having a number of different ingredients, it is noted that none of those ingredients include phloroglucinol.

In U.S. Patent Application Publication No. US 2018/0118983, an aqueous adhesive composition includes an aromatic polyaldehyde bearing at least two aldehyde functional groups and including at least one aromatic nucleus and a polyphenol including at least one aromatic nucleus. Generally, while phloroglucinol is disclosed in this reference (as the polyphenol), the composition does not include acetaldehyde, but rather requires an aromatic polyaldehyde, which makes the preparation of the dipping solution less efficient compared to conventional RFL technology due to the longer time required to complete reaction of polyphenol and aromatic polyaldehyde. Furthermore, polyaldehyde's are expensive materials and require especially vigorous stirring due to low solubility in the dipping composition

Thus, the need continues to exist for a RF resin-free dipping resin suitable for use with dipping adhesive compositions that is at least as efficient as conventional RFL technology, do not require expensive materials and can be solubilized in the dipping composition without vigorous stirring.

### SUMMARY OF THE INVENTION

At least one aspect of the present invention provides a phloroglucinolic acetaldehyde resin comprising the reaction product of a phloroglucinolic compound, such as a phloroglucinol, and acetaldehyde. In order to produce the phloroglucinolic acetaldehyde resin, the phloroglucinolic compound is reacted with the acetaldehyde in the presence of an organic solvent.

Generally, the phloroglucinolic acetaldehyde resin comprises a plurality of phloroglucinolic units defined by formula (I)

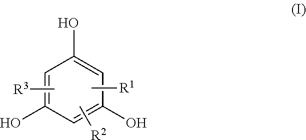

wherein the number of phloroglucinolic unit is an integer from 2 to 20, wherein at least one of R1, R2, and R3 combines with a second phloroglucinolic unit to form a methyl-substituted methylene bridge, and wherein the second and third ones of R1, R2 and R3 is either a hydrogen atom or combines with another phloroglucinolic unit to form another methyl-substituted methylene bridge, with the proviso that, for any terminal unit of formula (I), any two of R1, R2 and R3 are a hydrogen atom.

Another aspect of the invention provides a dipping adhesive composition for adhering a textile to a rubber compound, the dipping adhesive composition comprising a phloroglucinolic acetaldehyde resin and water, wherein the phloroglucinolic acetaldehyde resin is either solubilized or substantially homogeneously dispersed within the water. In one or more embodiments, the dipping adhesive composition further includes an unsaturated rubber latex. In one or more embodiments, the dipping adhesive composition may optionally include any additive that further enhances or promotes the adhesion of the textile to a rubber compound. Such adhesion promoter additives may be selected from the group consisting of blocked diisocyanates, aliphatic water soluble or dispersible epoxy compounds, or combinations thereof. The aliphatic water soluble or dispersible epoxy compounds should have good stability in a final solution.

Still another aspect of the invention provides a coated textile comprising the dipping adhesive composition above. That is, the coated textile is coated with a phloroglucinolic acetaldehyde resin comprising the reaction product of a phloroglucinolic compound and acetaldehyde. Generally, the coated textile may be produced by dipping the textile material into the dipping adhesive composition. The textile material may be selected from films, fibers, filaments, fabrics, cords and mixtures thereof. In one or more embodiments, the textile material is made of polyamide or polyester. In the same or other embodiments, the textile material is a fiber or a cord.

Yet another aspect of the invention provides a vulcanizable rubber composition comprising a vulcanizable rubber; a curative; and textile material coated with a dipping adhesive composition comprising a phloroglucinolic acetaldehyde resin. Advantageously, it will be appreciated that the vulcanized rubber compositions of the present invention exhibit advantageous rubber properties such as the adhesion properties compared to conventional products, such as RF resins.

### DETAILED DESCRIPTION

The present invention is based, at least in part, on the discovery of a phloroglucinolic acetaldehyde resin that can replace a resorcinol-formaldehyde (RF) resin for use in various applications including fiber or fabric dipping technologies as a dipped adhesive composition. As noted above, dipping technologies, typically in the form of dipping adhesive compositions, have been widely used throughout the rubber and tire industries to enhance the adhesion of rubber reinforcing materials such as fibers, films, filaments, fabrics or cords of polyesters (such as polyethylene terephthalate (PET) and polyethylene naphthalate (PEN)) and polyamides (such as nylons and aramids) to natural as well as synthetic rubbers. As with RF resins, the phloroglucinolic acetaldehyde resins are set forth in an aqueous or basic solvent, latex-based suspension or mixture. The fabrics, fibers or cords of textile material are then treated by dipping or otherwise coating the textile material with the aqueous latex suspension containing the phloroglucinolic acetaldehyde resin, which are essentially a dipping adhesive composition. The textile material coated with a dipping adhesive composition comprising a phloroglucinolic acetaldehyde resin can then be added to a vulcanizable rubber composition and a curative to provide a vulcanized rubber composition. It will be appreciated that phloroglucinolic acetaldehyde resin is a solid, and therefore, must be used in an aqueous or basic solvent latex suspension. Importantly, however, the composition does not include an resorcinol or formaldehyde. Instead, phloroglucinolic acetaldehyde resin is used.

The phloroglucinolic acetaldehyde resin of the present invention may be described as shown in Formula (I)

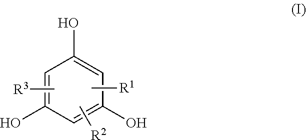

wherein the number of phloroglucinolic unit is an integer from 2 to 30, and at least one of R1, R2, and R3 combines with a second phloroglucinolic unit to form a methyl-substituted methylene bridge, where in the second and third ones of R1, R2 and R3 is a hydrogen atom or combines with another phloroglucinolic unit to form another methyl-substituted methylene bridge. That is, it will be appreciated that where R1, R2, or R3 of Formula (I) provides a methyl-substituted methylene bridge, a phloroglucinol unit will be attached to the other side of each bridge. Thus, there will be a second phloroglucinolic unit attached to the other side of the methyl-substituted methylene bridge of R1, a third phloroglucinolic unit attached to the other side of the methyl-substituted methylene bridge of R2, and a fourth phloroglucinolic unit attached to the other side of the methyl-substituted methylene bridge of R3. This will continue for the polymerization until the acetaldehyde is used up in the reaction mixture. If R1, R2, or R3 is not provided as a methyl-substituted methylene bridge, then a hydrogen atom is provided at those sites in Formula (I). Furthermore, it will be appreciated that, at any terminal unit of formula (1), any two of R1, R2 and R3 will both be a hydrogen atom. Thus, by a “terminal unit,” it is meant that there will be only one methyl-substituted methylene bridge at R1, R2 or R3 as shown in Formula (I) and no other such bridges.

In some embodiments, the number of phloroglucinolic unit is an integer from 2 to 30 and in other embodiments, the number of phloroglucinolic unit is an integer from 2 to 20. In further embodiments, the number of phloroglucinolic unit is an integer from 2 to 15 and is yet further embodiments, the number of phloroglucinolic unit is an integer from 2 to 10.

It will be appreciated that some embodiments of the phloroglucinolic acetaldehyde resin can be shown and described another way as well, and thus, the phloroglucinolic acetaldehyde resin of the present invention may be described as shown in Formula (II)

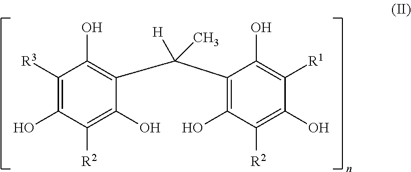

wherein n is an integer from 1 to 15, and wherein R1, both R2s, and R3 are either a methyl-substituted methylene bridge or a hydrogen atom, with the proviso that, for any terminal unit of formula (II), R1, R2 and R3 are a hydrogen atom. A methyl-substituted methylene bridge is already shown in Formula (II) between the two phloroglucinol units set forth therein. It will be appreciated that where R1, either R2, or R3 of Formula (II) provides such a methyl-substituted methylene bridge, a further phloroglucinol unit will be attached to the other side of the bridge. However, only up to 30 phloroglucinol units may extend from R1, either R2 or R3 before being terminated. In other embodiments, only up to 20 phloroglucinol units may extend from R1, either R2 or R3 before being terminated. In still other embodiments, only up to 10 phloroglucinol units may extend from R1, either R2, or R3 before being terminated. Thus, the chain of phloroglucinol units extending from R1, either R2 or R3 are not infinite. However, the reaction with the acetaldehyde will continue for the polymerization until the acetaldehyde is used up in the reaction mixture. If R1, either R2, or R3 is not provided as a methyl-substituted methylene bridge, then a hydrogen atom is provided at those sites in Formula (II). Furthermore, it will be appreciated that, at any terminal unit of formula (II), R2 and R3 of the left-side unit, or the R1 and R2 of the right-side unit will both be a hydrogen atom. Thus, by a “terminal unit,” for this formula, it is meant that there will be only the one methyl-substituted methylene bridge as shown in Formula (II) on the last end unit of phloroglucinol and R1 and R2 at one end and R3 and R2 at the other end will be a hydrogen atom.

In some embodiments, n is an integer from 1 to 15 and in other embodiments, n is an integer from 1 to 10. In further embodiments, n is an integer from 1 to 8 and is yet further embodiments, n is an integer from 1 to 5. It will be appreciated that n in Formula (II) is independent of the number of phloroglucinolic units in Formula (I), and should be viewed as separate formulas. As such, it will be appreciated that the number of phloroglucinolic units in Formula (II) may be higher or lower than the number of phloroglucinolic units in Formula (I).

The phloroglucinolic acetaldehyde resin of the present invention can be characterized by a molecular weight. It will be appreciated that the molecular weight of phloroglucinolic acetaldehyde resins can be determined using several methodologies, and the molecular weight is typically reported in terms of weight average molecular weight (Mw) or number average molecular weight (Mn). Useful techniques for determining the molecular weight of solid phloroglucinolic acetaldehyde resins include gel permeation chromatography using polystyrene standards (GPC) or vapor phase osmometry.

In one or more embodiments, the Mw of the resin is greater than 260 g/mole, in other embodiments greater than 310 g/mole, in other embodiments greater than 360 g/mole, in other embodiments greater than 450 g/mole, in other embodiments greater than 550 g/mole, and in other embodiments greater than 650 g/mole. In these or other embodiments, the Mw of the resin is less than 1900 g/mole, in other embodiments less than 1800 g/mole, in other embodiments less than 1700 g/mole, and in other embodiments less than 1600 g/mole. In these or other embodiments, the phloroglucinolic acetaldehyde resin of the present invention may be characterized by a Mw that is from about 260 g/mole to about 1900 g/mole, in other embodiments from about 310 g/mole to about 1800 g/mole, in other embodiments from about 450 g/mole to about 1700 g/mole, and in other embodiments from about 650 g/mole to about 1600 g/mole.

More specifically, and in one or more embodiments, the phloroglucinolic acetaldehyde resin of the present invention is generally prepared by reacting a phloroglucinolic compound with acetaldehyde in the presence of an organic solvent. It will be appreciated that, and as noted above, phloroglucinolic compounds include, but are not limited to, phloroglucinol, which is also referred to as trihydric phenol or 1,3,5-dihydroxy benzene, or free phloroglucinol. The chemical formula for phloroglucinol is set forth in Formula (III) below.

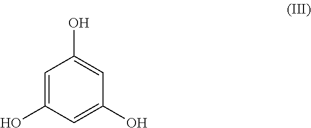

The molar ratio of acetaldehyde to phloroglucinol may vary from 0.1:1 to 5:1. In some other embodiments, the molar ratio may vary more than 0.2:1 to less than 5:1. In other embodiments, the molar ration may vary from 0.6:1 to 4:1, and in other embodiments, the molar ratio may vary from more than 0.6:1 to less than 3:1. In some embodiments, the molar ratio may desirably be less than 2:1 or even less than 1:1, while in other embodiments the molar ratio may be desirably more than 0.6:1, more than 0.7:1, more than 0.8:1, or even more than 1:1.

Examples of suitable organic solvents useful in the production of the phloroglucinolic acetaldehyde resins include polar solvents and the non-polar solvents. In use, solvent allows for the phloroglucinolic compound and the acetaldehyde to react and form the phloroglucinolic acetaldehyde resin. In one or more embodiment, the solvent may be selected from acetone, methyl isobutylketone (MIBK), methyl tert-butyl ether, cyclopentyl methyl ether, ethyl acetate, methanol, ethanol, isopropanol, n-propanol, acetonitrile, dimethyl sulfoxide, dimethyl formamide and tetrahydrofuran, chlorobenzene, dichlorobenzene, pentane, hexane, toluene and xylene. In one or more embodiments, methanol or ethanol are preferably used.

In one or more embodiments, the reaction (i.e., formation of the phloroglucinolic acetaldehyde resin) may be carried out in the temperature range of between 10 to 150° C. and, in other embodiments, from about 25 to about 130° C. In one embodiment, the reaction temperature is more than 30° C., while in another embodiment, the reaction temperature is more than 45° C. In yet another embodiment, the reaction temperature is more than 60° C., and in still another embodiment, the reaction temperature is more than 70° C.

In one or more embodiments, the reaction of the phloroglucinolic compound with the acetaldehyde takes place in the presence of threshold amounts of the organic solvent. Specifically, the amount of organic solvent present during the reaction can be described with reference to the amount of phloroglucinol (or other phloroglucinolic compound) charged to the reaction (i.e., the amount of phloroglucinol in the initial mixture). Generally, the initial mixture in which the reaction takes place includes greater than 20 parts by weight organic solvent per 100 parts by weight phloroglucinol. In some embodiments, greater than 35 parts by weight organic solvent per 100 parts by weight phloroglucinol are used, while in other embodiments, greater than 50 parts by weight organic solvent per 100 parts by weight phloroglucinol can be used. Generally, the phloroglucinol in organic solvent mixture (prior to aldehyde addition) in which the reaction takes place includes less than 500 parts by weight organic solvent per 100 parts phloroglucinol. In some embodiments, less than 400 parts by weight organic solvent per 100 parts by weight phloroglucinol are used, and in these and other embodiments less than 300 parts by weight organic solvent per 100 parts by weight phloroglucinol is used. In one or more embodiments, the mixture in which the reaction takes place includes from about 20 to about 500 parts by weight organic solvent per 100 parts by weight phloroglucinol. In other embodiments from about 35 to about 400 parts by weight organic solvent per 100 parts phloroglucinol, and in other embodiments from about. 50 to about 300 by weight organic solvent per 100 parts by weight phloroglucinol may be used.

Upon completion of the reaction, it will be appreciated that the resultant phloroglucinolic acetaldehyde resin is separated from the organic solvent by any manner known in the art. In one or more embodiments, the organic solvent may be evaporated or otherwise removed, such as by vacuum distillation, leaving the resin as the residue. The resin may then be discharged from its container to be used as desired. In one or more embodiments, the mixture can be separated using gas chromography. In one or more embodiments, the mixture can be filtered or decanted to separate the solid resin from the organic solvent.

The phloroglucinolic acetaldehyde resin of the present invention can then be mixed with water to form an aqueous dip adhesive composition. Such aqueous dip adhesive compositions containing phloroglucinolic acetaldehyde resin are prepared as single dip or two-step dip methods to treat a textile in various applications. Typically, such dip formulations can be used as aqueous dip adhesive compositions for adhering a textile to a rubber compound. The dipping adhesive composition comprises a phloroglucinolic acetaldehyde resin and water, wherein the phloroglucinolic acetaldehyde resin is either solubilized or substantially homogeneously dispersed within the water.

In the single dip method, an aqueous dip formulation is made by mixing the phloroglucinolic acetaldehyde resin with water. A pH adjustment may be made by the addition of an alkaline substances where necessary. In one or more embodiments, alkaline substances may be selected from the group consisting of sodium hydroxide, potassium hydroxide, calcium hydroxide, ammonia and ammonium hydroxide. In particular embodiments, alkaline substances are sodium hydroxide and ammonium hydroxide. An unsaturated rubber latex is them added to the dip formulation. The resultant dip adhesive composition is ready for immediate use or can be stored for about 24 hours to several weeks at room temperature prior to use.

In one or more embodiments, the unsaturated rubber latex may be selected from the group consisting of butadiene copolymer, polybutadienes, isoprene copolymers, poly-isoprenes, styrene-butadiene copolymers, and styrene-butadiene-vinyl-pyridine terpolymers. In particular embodiments, the unsaturated rubber latex is styrene-butadiene-vinyl-pyridine terpolymers.

In the two-step dip method, as a first dip solution, the textile is treated or coated with a subcoat solution comprising at least one adhesive compound selected from polyepoxide compounds, blocked polyisocyanate compounds or ethylene-urea compounds. A polyepoxide compound suitable for use comprises molecules containing one or more epoxy groups and includes epoxy compounds made from glycerol, pentaerythritol, sorbitol, ethylene glycol, polyethylene glycol and resorcinol. In at least one embodiment, the polyepoxide compound is devoid of any resorcinol. Of these adhesive compounds, the polyepoxides of polyalcohols are particularly suitable. The blocked polyisocyanates are selected from lactams, phenols and oximes blocked isocyanates comprising toluene diisocyanate, metaphenylene diisocyanate, diphenylmethane diisocyanate, triphenylmethane triisocyanate and hexamethylene diisocyanate. This subcoat solution treatment actually activates the fiber surface to enhance the interaction with the second dip solution, which is primarily a phloroglucinolic acetaldehyde resin as the main component, in the presence of water. Thus, in operation of the two-step method, a textile material is first dipped into a subcoat solution comprising an adhesive compound to activate and enhance the fiber surface for interaction with the second dip solution. The textile is then dipped into the second dip solution to provide a rubber reinforcing textile material.

The rubber reinforcing textile material that can be used to improve adhesive performance for various industrial applications, may be in the form of filament yarns, cords and woven fabrics comprising synthetic fibers such as polyamide fibers, polyester fibers, aromatic polyamide fibers and polyvinyl alcohol fibers and are characterized in that their surfaces have been coated with an adhesive composition for enhancing the textile material, phologlucinolic acetaldehyde resin and rubber interaction.

Generally, the process for adhering a textile material to rubber is well known in the art. Thus, for example, in the process for adhering a textile material such as polyester cords to rubber compounds, a conventional dipping machine is employed whereby the cords are continuously drawn through a dip bath containing the dipping adhesive composition produced by the one step method and prepared using the phloroglucinolic acetaldehyde resin made in accordance with embodiments of the invention. The excess dip is removed by blowing the cord with air jets, and the cord is dried in an oven set at 170° C. temperature for about 120 seconds. The cords are then cured at a temperature of about 230° C. for a sufficient time necessary for the penetration of the dip into the polyester cord. A cure time of about 60 seconds has been found to be suitable and acceptable in most instances.

For the purpose of testing the successful bonding of polyester cords to a vulcanizable rubber, the phloroglucinolic acetaldehyde resin-based adhesive-treated cords are embedded in a formulated and uncured rubber compound and then vulcanized. The rubber compound is vulcanized for a sufficient time and temperature to promote good adhesion, typically for about 15-18 minutes at 160° C. For specific testing, a standard H-adhesion testing method that follows ASTM D-4776 has been employed to determine the static adhesion of textile tire cords to rubber.

In light of this testing, it has been found that the resultant phloroglucinolic acetaldehyde resin-based adhesive-treated textile are useful in vulcanizable rubber compositions. Besides the use of the phloroglucinolic acetaldehyde resins of the present invention, the vulcanizable compositions may otherwise be conventional in nature. Accordingly, the rubber compositions may include a vulcanizable rubber, a curative, a filler, and a textile material coated with a dipping adhesive composition comprising a phloroglucinolic acetaldehyde resin of the present invention. Advantageously, it will be appreciated that the vulcanized rubber compositions of the present invention exhibit advantageous rubber properties such as the adhesion properties compared to conventional products, such as RF resins.

With regard to the rubber compositions of the present invention, the rubber compositions may include a rubber component that may include any natural rubber, synthetic rubber or combination thereof. Examples of synthetic rubber include but are not limited to styrene butadiene copolymer, polyisoprene, polybutadiene, acrylonitrile styrene, polychloroprene, polyisobutylene, ethylene-propylene copolymer and ethylene-propylene-diene rubber.

The rubber compositions may also include one or more of the normal additives used in such compositions. Examples of such additives include carbon black, cobalt salts, stearic acid, silica, silicic acid, sulfur, peroxides, zinc oxide, fillers, antioxidants and softening oils.

The rubber compositions are prepared and used in the conventional manner of preparing and using such compositions. For example, the compositions can be prepared by solid-state mixing.

In light of the foregoing, it will be appreciated that the rubber compositions produced according to the present invention may be used for various rubber applications or rubber goods. Polyester fibers, yarns, filaments, cords or fabric coated with the adhesive formulation of this invention may be used in tire applications or used to prepare portions of a radial, bias, or belted-bias passenger tires, truck tires, motorcycle or bicycle tires, off-the-road tires, airplane tires, transmission belts, V-belts, conveyer belts, hose, and gaskets. Other applications include rubber products that are useful for engine mounts and bushings. Still other examples of applications in which the uncured and cured rubber compositions of this invention may be used or used to prepare include technical or mechanical rubber goods such as hoses, pneumatic belts, and conveyor belts.

### EXAMPLES

In order to demonstrate the practice of the present invention, the following examples have been prepared and tested. The examples should not, however, be viewed as limiting the scope of the invention. The claims will serve to define the invention. The abbreviation PG below means “Phloroglucinolic Acetaldehyde.” PG Resins Examples 1-9 were prepared using the single step dip method, with Example 7 and 9 further providing an alkaline additive to provide a pH adjustment.

### PG Resin Example 1

50.0 g of phloroglucinol, 22.1 g of acetaldehyde 50 wt. % in ethyl alcohol, and 150.0 g of ethyl alcohol were charged to a flask and heated to 78° C. The reaction mixture was maintained at about 78° C. for 2 hours. Solvent was then removed by vacuum distillation and the resin was discharged from the flask.

### PG Resin Example 2

50.0 g of phloroglucinol, 24.5 g of acetaldehyde 50 wt. % in ethyl alcohol, and 150.0 g of ethyl alcohol were charged to a flask and heated to 78° C. The reaction mixture was maintained at about 78° C. for 2 hours. Solvent was then removed by vacuum distillation and the resin was discharged from the flask.

### PG Resin Example 3

50.0 g of phloroglucinol, 26.9 g of acetaldehyde 50 wt. % in ethyl alcohol, and 150.0 g of ethyl alcohol were charged to a flask and heated to 78° C. The reaction mixture was maintained at about 78° C. for 2 hours. Solvent was then removed by vacuum distillation and the resin was discharged from the flask.

### PG Resin Example 4

50.0 g of phloroglucinol, 30.1 g of acetaldehyde 50 wt. % in ethyl alcohol, and 150.0 g of ethyl alcohol were charged to a flask and heated to 78° C. The reaction mixture was maintained at about 78ºC for 2 hours. Solvent was then removed by vacuum distillation and the resin was discharged from the flask.

### PG Resin Example 5

50.0 g of phloroglucinol, 34.1 g of acetaldehyde 50 wt. % in ethyl alcohol, and 150.0 g of ethyl alcohol were charged to a flask and heated to 78° C. The reaction mixture was maintained at about 78° C. for 2 hours. Solvent was then removed by vacuum distillation and the resin was discharged from the flask.

### PG Resin Example 6

50.0 g of phloroglucinol, 39.4 g of acetaldehyde 50 wt. % in ethyl alcohol, and 150.0 g of ethyl alcohol were charged to a flask and heated to 78° C. The reaction mixture was maintained at about 78° C. for 2 hours. Solvent was then removed by vacuum distillation and the resin was discharged from the flask.

### PG Resin Example 7

50.0 g of phloroglucinol, 26.9 g of acetaldehyde 50 wt. % in ethyl alcohol, and 150.0 g of ethyl alcohol were charged to a flask and heated to 78° C. The reaction mixture was maintained at about 78° C. for 2 hours. Solvent was then removed by vacuum distillation. Then 200.0 g of distilled water and 14.0 g of sodium hydroxide were charged and solvent was then removed by distillation to obtain 130.0 g aqueous solution. The solid content is 49.2%.

### PG Resin Example 8

50.0 g of phloroglucinol, 19.2 g of acetaldehyde 50 wt. % in ethyl alcohol, and 150.0 g of ethyl alcohol were charged to a flask and heated to 78° C. The reaction mixture was maintained at about 78° C. for 2 hours. Solvent was then removed by vacuum distillation and the resin was discharged from the flask.

### PG Resin Example 9

250.0 g of phloroglucinol, 157.3 g of acetaldehyde 50 wt. % in ethyl alcohol, and 750.0 g of ethyl alcohol were charged to a flask and heated to 78° C. The reaction mixture was maintained at about 78° C. for 2 hours. Solvent was then removed by vacuum distillation. Then 800.0 g of distilled water and 70.0 g of sodium hydroxide were charged and solvent was then removed by distillation to obtain 815.0 g aqueous solution. The solid content is 39.8%.

The various physical properties and chemical analysis of the phloroglucinolic acetaldehyde resin are provided in TABLE 1 below. It will be appreciated that, in evaluating the resin properties, the molecular weight and oligomer distribution was determined by GPC analysis. The reaction product of phloroglucinol and acetaldehyde was analyzed by proton NMR spectroscopic methods. The molar ratio was acetaldehyde (A) to phloroglucinol (Phg) to synthesize the phloroglucinolic acetaldehyde resin.

TABLE 1

| | Phloroglucinolic Acetaldehyde Resin | | | | | | | | |
|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 |
| Molar Ratio A:Phg | 0.63 | 0.70 | 0.77 | 0.86 | 0.98 | 1.13 | 0.77 | 0.55 | 0.91 |

NMR Analysis (number per aromatic ring)

| | | | | | | | | | |
|---|---|---|---|---|---|---|---|---|---|
| Aromatic Hydrogens | 1.97 | 2.00 | 1.72 | 1.25 | 1.21 | 1.02 | 1.53 | 2.11 | 1.22 |
| Ethylidene bridges | 1.03 | 1.00 | 1.28 | 1.75 | 1.79 | 1.98 | 1.47 | 0.89 | 1.78 |

GPC Analysis

| | | | | | | | | | |
|---|---|---|---|---|---|---|---|---|---|
| Monomer (%) | 17.0 | 12.6 | 10.6 | 4.9 | 3.8 | 2.9 | 7.7 | 21.4 | 4.9 |
| Dimer (%) | 15.5 | 12.5 | 11.6 | 10.6 | 5.4 | 5.7 | 12.1 | 21.9 | 9.9 |
| Trimer (%) | 13.4 | 11.8 | 10.7 | 11.0 | 6.3 | 6.5 | 19.6 | 15.6 | 12.3 |
| Tetramer (%) | 16.3 | 14.2 | 8.6 | 13.8 | 8.6 | 5.3 | 11.2 | 10.6 | 10.3 |
| Penta+ (1000+) (%) | 37.8 | 48.9 | 58.5 | 59.7 | 75.9 | 79.6 | 49.4 | 30.5 | 62.6 |
| Mn | 558 | 651 | 700 | 784 | 963 | 992 | 713 | 486 | 757 |
| Mw | 763 | 952 | 1035 | 1031 | 1472 | 1526 | 893 | 639 | 988 |

In comparison between the phloroglucinolic acetaldehyde resins of the present invention, it will be appreciated that those phloroglucinolic acetaldehyde resins (Exs.1-7 and 9) having a molar ratio of 0.6 to 1 or higher of acetaldehyde to phloroglucinol (A:Phg) provides a higher percentage of tetramer and pentamer than did the phloroglucinolic acetaldehyde resin (Ex. 8) having less than a 0.6 to 1 molar ratio of A:Phg, and also had more ethylidene bridges, while having fewer aromatic hydrogens. As noted in TABLE 4, this may have affected the dipping solution stability of the resin with a less than 0.6 to 1 molar ratio.

It will be appreciated that, in order to provide a full analysis of the improvements provided by the uniquely prepared solid phloroglucinolic acetaldehyde resins above, a resorcinol formaldehyde resin, available from Sumitomo Chemical under the tradename PENACOLITE® RESIN R-2170 was provided as a comparative RF resin. All of the above Examples, including the comparative RF resin were then used in the preparation of a dipping adhesion composition.

A tire cord was dipped into the dipping adhesion composition which was prepared using the two-step dip method. The complete adhesive formulation solutions are shown in TABLE 2. The first step is a sub-coating (identified as Subcoat solution in TABLE 2) in a first bath and is based on a caprolactam-blocked methylene-bis-(4-phenyl isocyanate) emulsion, available from EMS-Griltech under the tradename GRILLBOND IL-6, and glycerol polyglycidyl ether available from Nagase Chemtech Corporation under tradename DENACOL EX313. The second step is a top-coating (identified as Resin solution in TABLE 2) in a second bath shown in TABLE 2. In the preparation, a phloroglucinolic acetaldehyde resin, distilled water, and 50% Sodium hydroxide were mixed first, and then 41% 2-vinyl pyridine styrene-butadiene rubber (SBR) latex was added with good mixing. Ammonium hydroxide was charged to obtain the final mix solution. The final solution of examples 1 to 7 was found to be stable for 1 week at room temperature. However, the final solution of example 8 was found not stable at room temperature, and there was a floating material in the solution after 24 hours. The results of the final solution stability are shown in TABLE 4.

TABLE 2
Formulation (parts by weight).

| Subcoat solution (Weights in Gram) | |
|---|---|
| Distilled Water | 365.6 |
| 50% Grillbond IL-6 | 28.8 |
| (caprolactam-blocked methylene-bis-(4-phenyl isocyanate) | |
| Denacol EX313 (glycerol polyglycidyl ether) | 5.6 |
| Total | 400.0 |
| Resin Solution (Weights in Gram) | |
| Distilled Water | 98.1 |
| 50% Sodium Hydroxide | 1.9 |
| Phloroglucinolic acetaldehyde resins (PG Resin) or | 6.4 |
| PENTACOLITE ® RESIN R-2170 (RF Resin), solids basis | |
| 41% 2-Vinyl Pyridine SBR Latex | 88.9 |
| 29.5% Ammonium Hydroxide | 4.8 |
| Total | 200.1 |

The tire cord used in the preparation of the Examples was made from two polyethylene terephthalate (PET) yarns of 1500 denier. Each tire cord (also referred to as 1500/2 cord) was used in the adhesive performance evaluations as conducted below. This cord was a non-adhesive activated (NAA) PET. These cords were dipped in the subcoat dip solution (i.e., the Subcoat solution in TABLE 2) prepared as above. Upon being dipped, the dipped cords were then dried under tension for 120 seconds in a first oven set at 210° C. They were then dipped in the top coat dip solution (i.e., the Resin solution in TABLE 2) prepared as above, and then dried under tension for 120 seconds in a second oven set at 135° C. The resultant dipped cords were then cured for 120 seconds in a third oven set at 240° C. Finally, the PG resin-based adhesive dip solution-treated polyethylene terephthalate cords were embedded in a formulated and uncured rubber and cured at 160º C for 16 minutes, and the resultant samples were tested in an H-pull adhesion test conducted according to ASTM method D-4776).

Thus, dipped cord specimens containing the phloroglucinolic acetaldehyde resins described in the examples 1-8 and in in Ex. 1-8 of TABLE 1, as well as the comparative RF resin, were prepared according to the rubber composition shown in TABLE 3.

TABLE 3
Formulation (parts by weight).

| | |
|---|---|
| Natural Rubber | 70 |
| SBR | 30 |
| Carbon Black (N660) | 60 |
| Zinc Oxide | 4 |
| Stearic Acid | 2 |
| Naphthenic oil | 6 |
| Polymerized 1,2-Dihydro-2,2,4-Trimethylquinoline | 1.8 |
| Sulfur | 3.1 |
| 2,2′-Dithiobis(Benzothiazole) | 0.8 |

Dipped cord specimens containing each of the eight phloroglucinolic acetaldehyde resins set forth in TABLE 1 were then tested against a dipped cord specimen containing the comparative RF resin (Comparative Example 1).

The stability of the dipping solutions and the H-pull adhesion test are provided in TABLE 4 below, Humidity Aged Adhesion and Heat Aged Adhesion were also tested.

TABLE 4
Rubber performance of Examples 1-8, Comparative Example 1

| | |
|---|---|
| Phloroglucinolic Acetaldehyde Resins | RF Resin |

Rubber Performance

| | | | | | | | | |
|---|---|---|---|---|---|---|---|---|
| | | | | | | | | Comp |
| Ex. 8 | Ex. 1 | Ex. 2 | Ex. 3 | Ex. 4 | Ex. 5 | Ex. 6 | Ex.. 7 | Ex. 1 |

UNAGED ADHESION (3/8″ Mold, 160° C. Cure)

| | | | | | | | | | |
|---|---|---|---|---|---|---|---|---|---|
| Adhesion [N] | 209 | 214 | 183 | 210 | 222 | 209 | 200 | 221 | 146 |
| Rubber Coverage [%] | 100% | 100% | 90% | 100% | 100% | 100% | 100% | 100% | 90% |
| Energy [N-m] | 1.49 | 1.64 | 1.27 | 1.52 | 1.69 | 1.59 | 1.44 | 1.55 | 0.88 |

HUMIDITY UNAGED ADHESION (7 days 85° C. 90%, 3/8″ Mold, 160° C. Cure

| | | | | | | | | | |
|---|---|---|---|---|---|---|---|---|---|
| Adhesion [N] | 98.9 | 96.3 | 110.1 | 102.3 | 114.8 | 108.1 | 110.9 | 117 | 107.6 |
| Rubber Coverage [%] | 80% | 80% | 80% | 85% | 100% | 85% | 85% | 90% | 75% |
| Energy [N-m] | 0.44 | 0.42 | 0.53 | 0.48 | 0.56 | 0.53 | 0.5 | 0.63 | 0.54 |

HEAT AGED ADHESION (7 days 100° C., 3/8″ Mold, 160° C. Cure)

| | | | | | | | | | |
|---|---|---|---|---|---|---|---|---|---|
| Adhesion [N] | 93.6 | 95.3 | 127.9 | 106 | 118.2 | 98.3 | 109.5 | 117.4 | 95.2 |
| Rubber Coverage [%] | 95% | 95% | 95% | 90% | 100% | 100% | 100% | 90% | 100% |
| Energy [N-m] | 0.29 | 0.26 | 0.4 | 0.32 | 0.36 | 0.32 | 0.35 | 0.39 | 0.35 |
| Dipping Solution | X | ◯ | ◯ | ◯ | ◯ | ◯ | ◯ | ◯ | ◯ |
| Stability | | | | | | | | | |

In comparison between the phloroglucinolic acetaldehyde resins of the present invention and conventional resorcinol formaldehyde (RF) resin, it will be appreciated that the phloroglucinolic acetaldehyde resins of the present invention provides better unaged adhesion properties compared to the conventional resorcinol formaldehyde resin, while the humidity unaged adhesion properties and the heat aged adhesion properties remained relatively consistent.

The following provides a second dipping example. The cord was dipped into the dipping adhesion composition which was prepared using the two-step dip method. The complete adhesive formulation solutions are shown in TABLE 5. The first step is a sub-coating (identified as Subcoat solution in TABLE 5) in a first bath is based on a bis(2-ethylhexyl)sulfosuccinic acid sodium salt, available from Fisher scientific under the tradename Aerosol® OT, and glycerol polyglycidyl ether available from Nagase Chemtech Corporation under tradename DENACOL EX313. The second step is a top-coating (identified as Resin solution in TABLE 5) in a second bath shown in TABLE 5. In the preparation, a phloroglucinolic acetaldehyde resin, distilled water, and 29.5% ammonium hydroxide were mixed first, and then 41% 2-vinyl pyridine styrene-butadiene rubber (SBR) latex was added with good mixing. The final solution of example 9 was found to be stable for 1 week at room temperature.

TABLE 5
Formulation (parts by weight).

| Subcoat solution (Weights in Gram) | |
|---|---|
| Distilled Water | 293.0 |
| 75% Aerosol ® OT | 0.1 |
| (bis(2-ethylhexyl)sulfosuccinic acid sodium salt) | |
| Denacol EX313 (glycerol polyglycidyl ether) | 6.7 |
| 50% Sodium Hydroxide | 0.2 |
| Total | 300.0 |

| Resin Solution (Weights in Gram) | |
|---|---|
| Distilled Water | 98.4 |
| 29.5% Ammonium Hydroxide | 2.4 |
| Phloroglucinolic acetaldehyde resins (PG Resin) or | 8.5 |
| PENTACOLITE ® RESIN R-2170 (RF Resin), solids basis | |
| 41% 2-Vinyl Pyridine SBR Latex | 99.7 |
| Total | 200.0 |

The type of cord used in preparation of a second Example was made from two aramid yarns of 1680 denier. Each tire cord (also referred to as 1680/2 cord) was used in the adhesive performance evaluations as conducted below. This cord was a non-adhesive activated (NAA) aramid. These cords were dipped in the subcoat dip solution (i.e., the Subcoat solution in TABLE 5) prepared as above. Upon being dipped, the dipped cords were then dried under tension for 120 seconds in a first oven set at 240° C. They were then dipped in the top coat dip solution (i.e., the Resin solution in TABLE 5) prepared as above, and then dried under tension for 120 seconds in a second oven set at 145° C. The resultant dipped cords were then cured for 120 seconds in a third oven set at 240° C. Finally, the PG resin-based adhesive dip solution-treated aramid cords were embedded in a formulated and uncured rubber and cured at 160º C for 16 minutes, and the resultant samples were tested in an H-pull adhesion test conducted according to ASTM method D-4776).

Thus, dipped cord specimens containing the phloroglucinolic acetaldehyde resins described in example 9, as well as the comparative RF resin, were prepared according to the rubber composition shown in TABLE 5.

The dipped cord specimens containing the phloroglucinolic acetaldehyde resin described in example 9 was then tested as against a dipped cord specimen containing the comparative RF resin (Comparative Example 2).

The stability of the dipping solutions and the H-pull adhesion test are provided in TABLE 6 below. Humidity Aged Adhesion and Heat Aged Adhesion were also tested.

TABLE 6
Rubber performance of Examples 9 and Comparative Example 2

| | Ex. 9 | Comp. Ex. 2 |
|---|---|---|
| Rubber Performance | | |
| UNAGED ADHESION | | |
| (⅜″ Mold, 160° C. Cure) | | |
| Adhesion [N] | 170.7 | 145.7 |
| Rubber Coverage [%] | 100% | 80% |
| Energy [N-m] | 1.13 | 0.88 |
| HUMIDITY AGED ADHESION | | |
| (7 days 85° C. 90%, ⅜″ | | |
| Mold, 160° C. Cure) | | |
| Adhesion [N] | 120.5 | 129.3 |
| Rubber Coverage [%] | 100% | 100% |
| Energy [N-m] | 0.52 | 0.51 |
| HEAT AGED ADHESION | | |
| (7 days 100° C., ⅜″ Mold, | | |
| 160° C. Cure) | | |
| Adhesion [N] | 102.4 | 107.4 |
| Rubber Coverage [%] | 100% | 100% |
| Energy [N-m] | 0.28 | 0.32 |
| Dipping Solution Stability | ◯ | ◯ |

In comparison between the phloroglucinolic acetaldehyde resins of the present invention and conventional resorcinol formaldehyde (RF) resin, it will be appreciated that the phloroglucinolic acetaldehyde resins of the present invention provides better unaged adhesion properties compared to the conventional resorcinol formaldehyde resin, while the humidity unaged adhesion properties and the heat aged adhesion properties remained relatively consistent.

Various modifications and alterations that do not depart from the scope and spirit of this invention will become apparent to those skilled in the art. This invention is not to be duly limited to the illustrative embodiments set forth herein.

1. The phloroglucinolic acetaldehyde resin comprising a plurality of phloroglucinolic units defined by formula (I) 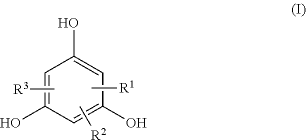
wherein the number of phloroglucinolic unit is an integer from 2 to 20, wherein at least one of R1, R2, and R3 combines with a second phloroglucinolic unit to form a methyl-substituted methylene bridge, and wherein the second and third ones of R1, R2 and R3 is either a hydrogen atom or combines with another phloroglucinolic unit to form another methyl-substituted methylene bridge, with the proviso that, for any terminal unit of formula (I), two of R1, R2 and R3 are a hydrogen atom.

2. The phloroglucinolic acetaldehyde resin as claimed in claim 1, wherein the resin includes less than 20 wt. % unreacted phloroglucinol.

3. The phloroglucinolic acetaldehyde resin as claimed in claim 1, wherein the resin has a Mw of greater than 650 and less than 1600 g/mole.

4. The phloroglucinolic acetaldehyde resin as claimed in claim 1, wherein the resin has pentamer or higher oligomer content of less than 85% according to GPC using a polystyrene standard.

5. The phloroglucinolic acetaldehyde resin as claimed in claim 1, wherein the molar ratio of acetaldehyde to phloroglucinol is 0.6 to 1 or higher.

6. A dipping adhesive composition comprising the phloroglucinolic acetaldehyde resin as claimed in claim 1.

7. The dipping adhesive composition of claim 6, comprising an unsaturated rubber latex.

8. The dipping adhesive composition as claimed in claim 6, wherein the composition includes a basic solvent.

9. The dipping adhesive composition as claimed in claim 6, wherein the pH of the composition is greater than 6 and less than 13.

10. The dipping adhesive composition as claimed in claim 6, wherein an unsaturated rubber latex is a diene elastomer selected from the group consisting of butadiene copolymer, polybutadienes, isoprene copolymers, poly-isoprenes, styrene-butadiene copolymers, styrene-butadiene-vinyl-pyridine terpolymers and mixtures thereof.

11. The dipping adhesive composition as claimed in claim 6, wherein a content of phloroglucinolic acetaldehyde resin is greater than 0.1% and less than 10% by solid weight, wherein the amount in % by weight is based on the total weight of the dipping adhesive composition.

12. A coated textile with dipping adhesive compositions as claimed in claim 6.

13. A process for coated a textile with dipping adhesive compositions as claim 12, wherein heat treating the dipped material at a temperature from 100 to 240° C.

14. The textile material as claimed in claim 12, wherein the textile material is a material selected from films, fibers, filaments, fabrics and cords and mixtures thereof.

15. The textile material as claimed in claim 12, wherein the textile material is polyamide and polyester.

16. A vulcanizable rubber composition comprising:
a vulcanizable rubber;
a curative; and
a textile material with dipping adhesive composition as claimed in claim 12.

17. A vulcanized rubber prepared from the vulcanizable composition of claim 16.
